(19) United States
(12) Patent Application Publication
(10) Pub. No.: US 2020/0334437 A1
(43) Pub. Date: Oct. 22, 2020

(54) OPTICAL FINGERPRINT DETECTING SYSTEM

(71) Applicant: HIMAX TECHNOLOGIES LIMITED, Tainan City (TW)

(72) Inventors: Jia-Ming He, Tainan City (TW); Yaw-Guang Chang, Tainan City (TW)

(21) Appl. No.: 16/430,328

(22) Filed: Jun. 3, 2019

Related U.S. Application Data
(60) Provisional application No. 62/837,022, filed on Apr. 22, 2019.

(51) Int. Cl. G06K 9/00; G06K 9/03; G06K 9/20

(52) U.S. Cl. CPC G06K 9/0004; H04M 1/725; G06K 9/209; G06K 9/03

(57) ABSTRACT

An optical fingerprint detecting system includes a detection circuit with a differential pair of two inputs including a first input and a second input; a plurality of first photo detectors; a plurality of first switches that are electrically connected at first ends to the first photo detectors respectively, and are electrically connected at second ends together to the first input of the detection circuit via a sense line; and a plurality of second switches that are electrically connected at first ends together to the second input of the detection circuit via a reference line.

### CROSS-REFERENCE TO RELATED APPLICATIONS

This application claims the benefit of U.S. Provisional Application No. 62/837,022, filed on Apr. 22, 2019, the entire contents of which is herein expressly incorporated by reference.

### BACKGROUND OF THE INVENTION

### 1. Field of the Invention

The present invention generally relates to fingerprint detection, and more particularly to an optical fingerprint detecting system with differential signaling.

### 2. Description of Related Art

A mobile device, such as a mobile phone, is a computing device small enough to hold and operate in the hand. The mobile device typically has a touchscreen that occupies substantial front surface (e.g., 70%) of the mobile device.

Fingerprint is one of many forms of biometrics used to identify individuals and verify their identity in order to protect confidential or sensitive data stored in the mobile devices. Fingerprint recognition is not only a secure way of identifying individuals, but also a quick means for accessing the mobile device.

Many mobile devices (e.g., mobile phones) have been equipped with fingerprint recognition, which is typically implemented with a physical button disposed on the front surface, for example, below and external to the touchscreen. Placing a fingerprint button on the front surface of the mobile devices is unfortunately in contradiction with the trend toward a bigger touchscreen that can accommodate more functions as the mobile devices become more powerful.

FIG. 1 shows a schematic diagram illustrating a conventional mobile phone 100, which has a display area 11 and a detection area 12 for detecting a fingerprint. The detection area 12 is commonly disposed out of (e.g., below) the display area 11. As the detection area 12 occupies a substantive and precious portion of the top surface of the mobile phone 100, the display area 11 thus cannot make full use of the top surface of the mobile phone 100.

Optical fingerprint detection is one of fingerprint detection techniques. However, the optical fingerprint detection may be susceptible to some noise sources. A need has thus arisen to propose a novel mechanism for overcoming the drawbacks of conventional optical fingerprint detection.

### SUMMARY OF THE INVENTION

In view of the foregoing, it is an object of the embodiment of the present invention to provide an optical fingerprint detecting system with differential signaling capable of correctly detecting fingerprint without being influenced by noise sources.

According to one embodiment, an optical fingerprint detecting system includes a detection circuit, a plurality of first photo detectors, a plurality of first switches and a plurality of second switches. The detection circuit has a differential pair of two inputs including a first input and a second input. The first switches are electrically connected at first ends to the first photo detectors respectively, and are electrically connected at second ends together to the first input of the detection circuit via a sense line. The second switches are electrically connected at first ends together to the second input of the detection circuit via a reference line.

### BRIEF DESCRIPTION OF THE DRAWINGS

FIG. 1 shows a schematic diagram illustrating a conventional mobile phone;

FIG. 2 shows a schematic diagram illustrating a mobile device according to one embodiment of the present invention;

FIG. 3A shows a block diagram illustrating an optical fingerprint detecting system according to one embodiment of the present invention;

FIG. 3B shows a circuit diagram illustrating the optical fingerprint detecting system according to the embodiment of the present invention;

FIG. 4 shows a circuit diagram illustrating sense switches, photo detectors (PDs) and a detection circuit;

FIG. 5 shows a circuit diagram illustrating an optical fingerprint detecting system according to a first embodiment of the present invention;

FIG. 6A schematically shows a top view of a display area of a mobile device according to a second embodiment of the present invention;

FIG. 6B shows a circuit diagram illustrating an optical fingerprint detecting system according to the second embodiment of the present invention;

FIG. 7 shows a circuit diagram illustrating an optical fingerprint detecting system according to a third embodiment of the present invention; and

FIG. 8A and FIG. 8B show circuit diagrams illustrating an optical fingerprint detecting system according to a fourth embodiment of the present invention.

### DETAILED DESCRIPTION OF THE INVENTION

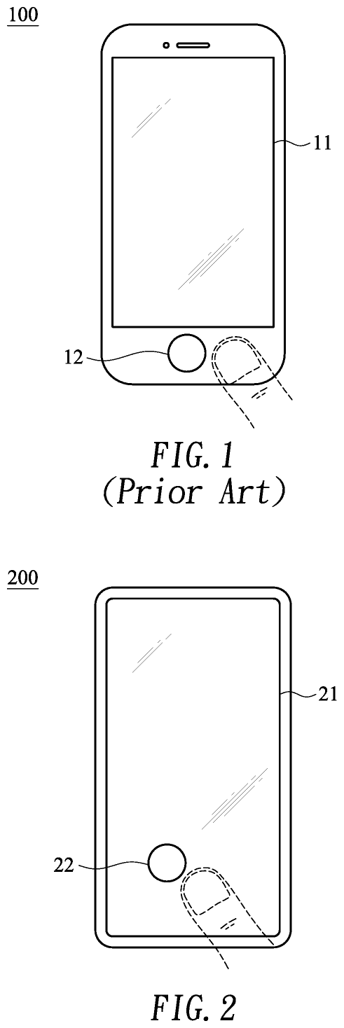

FIG. 2 shows a schematic diagram illustrating a mobile device 200, such as a mobile phone, according to one embodiment of the present invention. Specifically, the mobile device 200 may include a display area 21, within which a detection area 22 is disposed for detecting a fingerprint. According to one aspect of the embodiment, the detection area 22 utilizes an optical fingerprint imaging technique. Compared to the conventional mobile phone 100 of FIG. 1, the display area 21 of the mobile device 200 may be made larger than the display area 11 of the conventional mobile phone 100.

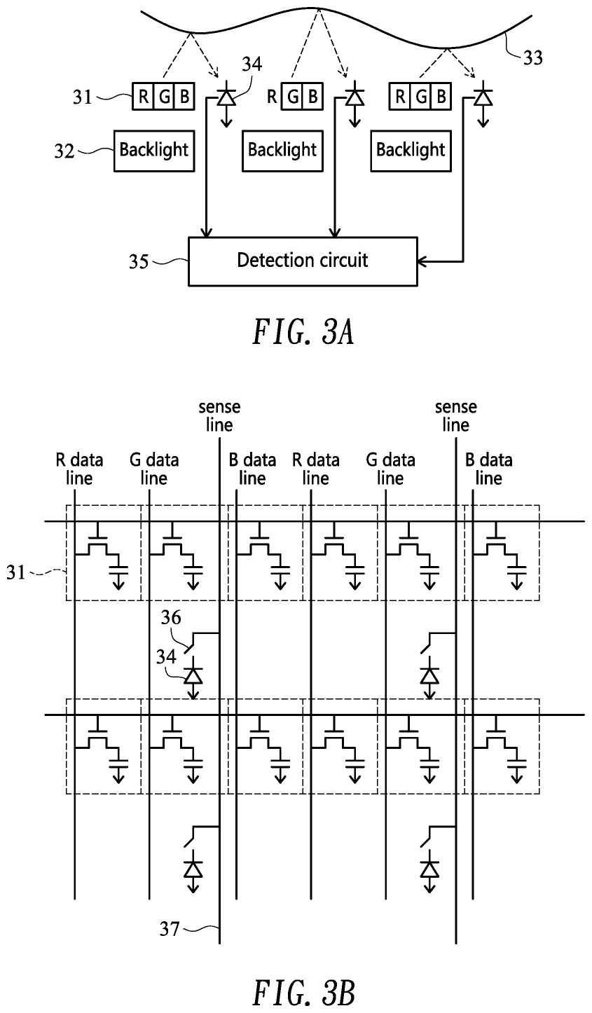

FIG. 3A shows a block diagram illustrating an optical fingerprint detecting system according to one embodiment of the present invention, and FIG. 3B shows a circuit diagram illustrating the optical fingerprint detecting system according to the embodiment of the present invention. Specifically, the system may include cells 31 (e.g., red-green-blue cells or RGB cells), through which light (e.g., generated by a backlight 32 of a liquid crystal display or generated by the cells 31 themselves as in a light-emitting diode display) passes and then illuminates the surface of a finger 33. The light reflected from the finger 33 is received by photo detectors (PDs) 34, such as photo diodes, which capture an image of fingerprint of the finger 33. The captured image of the fingerprint is converted by the PDs 34 into a corresponding electrical signal, which is then fed to a detection circuit 35 through respective sense switches 36 and (PD) sense lines 37.

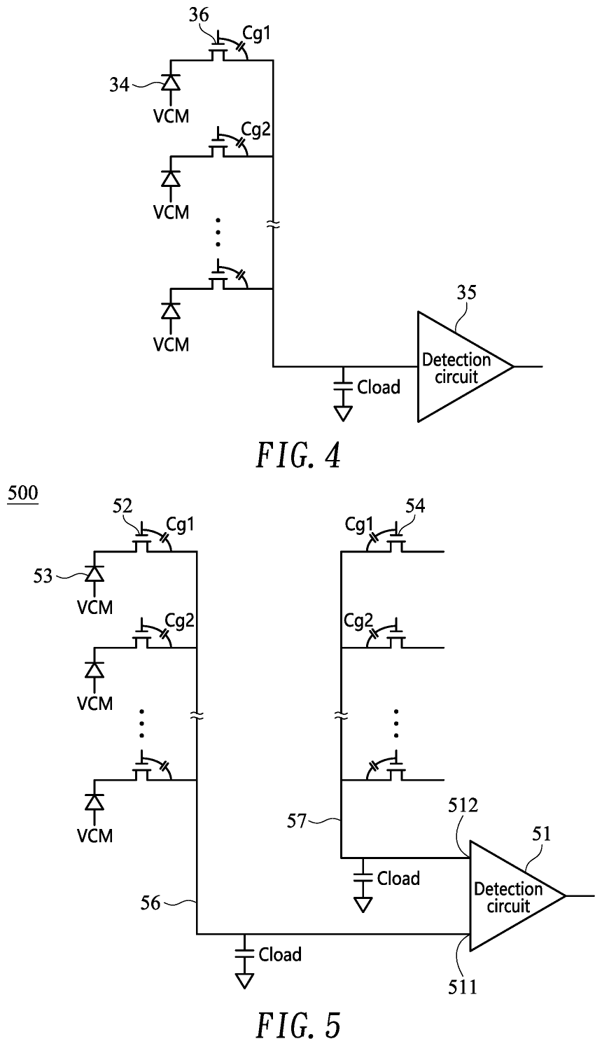

FIG. 4 shows a circuit diagram illustrating sense switches 36, photo detectors (PDs) 34 and a detection circuit 35. Specifically, the sense switches 36 are electrically connected at first ends to the photo detectors 34 respectively, and are electrically connected together at second ends to the detection circuit 35. It is noted that the photo detectors 34 and the sense switches 36 are commonly made in a (display) panel, while the detection circuit 35 is made in an integrated circuit apart from the panel. As a result, a trace 37 between the photo detectors 34/sense switches 36 and the detection circuit 35 has a non-negligible length, which may incur parasitic capacitance. On the other hand, the photo detector 34 normally generates a current with a very small amount, for example, 1 pA. Therefore, a signal received by the detection circuit 35 may be susceptible to some noise sources. For example, the signal received by the detection circuit 35 may be affected by noise generated from turning on or off the sense switch 36 through coupling capacitance, for example, Cg1 and Cg2. In another example, an unstable bias voltage VCM connected to the anode of the photo detector 34 may affect the signal received by the detection circuit 35. In a further example, parasitic capacitance (e.g., Cload) of the trace 37 may affect the detection of the detection circuit 35 due to noise coupled to the parasitic capacitance.

FIG. 5 shows a circuit diagram illustrating an optical fingerprint detecting system 500 according to a first embodiment of the present invention capable of overcoming the drawbacks associated with FIG. 4. Only one channel (or column) of cells has been illustrated for brevity. According to one aspect of the embodiment, differential signaling is adopted in the embodiment. Specifically, the system 500 may include a detection circuit 51 with a differential pair of inputs (e.g., a positive input and a negative input). In one exemplary embodiment, the detection circuit 51 may include a differential amplifier that amplifies difference (voltage) between the two inputs (of the differential pair) but suppresses any voltage common to the two inputs (of the differential pair).

The optical fingerprint detecting system 500 of the embodiment may include first (sense) switches 52 that are electrically connected at first ends to (first) photo detectors 53 respectively, and are electrically connected at second ends together to a first input 511 of the detection circuit 51 via a sense line 56. The system 500 of the embodiment may include second (reference) switches 54 that are electrically connected at first ends together to a second input 512 of the detection circuit 51 via a reference line 57. Second ends of the second switches 54 may, for example, be connected to a constant bias voltage. It is noted that the second switches 54 and the first switches 52 are symmetrically manufactured such that a same pair of the first switch 52 and the second switch 54 may have the substantially same coupling capacitance. For example, the top first switch 52 and the top second switch 54 may have the substantially same coupling capacitance Cg1, and the one next to the top first switch 52 and the one next to the top second switch 54 may have the substantially same coupling capacitance Cg2.

In operation, the first switches 52 are controllably turned on in a predetermined sequence, while the second switches 54 are always turned off. As the first switches 52 and the second switches 54 are symmetrically made, the generated noise due to the coupling capacitance (e.g., Cg1) and the parasitic capacitance (e.g., Cload) may be suppressed by the differential pair of inputs 511 and 512. Therefore, the signal received by the detection circuit 51 may not be susceptible to noise sources.

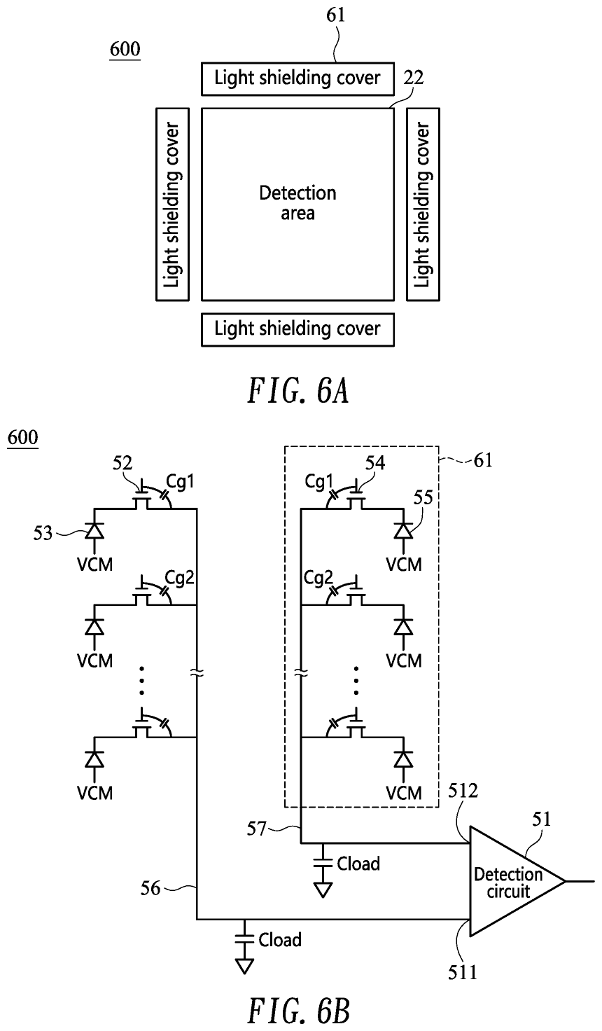

FIG. 6A schematically shows a top view of a display area of a mobile device according to a second embodiment of the present invention, and FIG. 6B shows a circuit diagram illustrating an optical fingerprint detecting system 600 according to the second embodiment of the present invention capable of overcoming the drawbacks associated with FIG. 4. According to one aspect of the embodiment, at least one light shielding cover 61 is disposed on a periphery of a detection area 22.

The circuitry of the system 600 is similar to that of the system 500 (FIG. 5) with the exception that second ends of the second switches 54 are electrically connected to second photo detectors 55 respectively. In the embodiment, the second switches 54 and the second photo detectors 55 are covered by the light shielding cover 61, while the first switches 52 and the first photo detectors 53 are not covered by the light shielding cover 61 (but in the detection area 22).

In operation, the first switches 52 and the second switches 54 are controllably turned on in a predetermined sequence. It is noted that a same pair of the first switch 52 and the second switch 54 are either turned on or off at the same time. As the first switches 52 and the second switches 54 are symmetrically made, the generated noise due to the coupling capacitance (e.g., Cg1), the parasitic capacitance (e.g., Cload) and the unstable bias voltage VCM may be suppressed by the differential pair of inputs 511 and 512. Moreover, current change in the photo detectors 53 and 55 due to environment (e.g., temperature) change may also be suppressed by the differential pair of inputs 511 and 512. Therefore, the signal received by the detection circuit 51 may not be susceptible to noise sources.

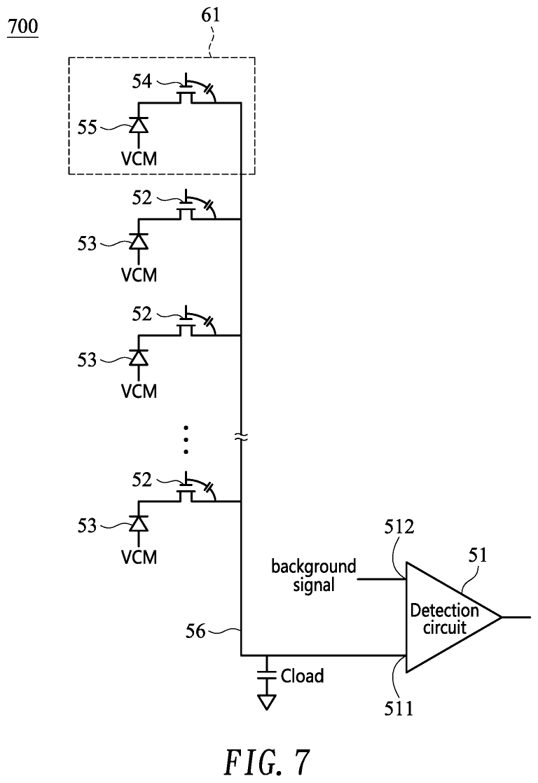

FIG. 7 shows a circuit diagram illustrating an optical fingerprint detecting system 700 according to a third embodiment of the present invention capable of overcoming the drawbacks associated with FIG. 4. Only one channel (or column) of cells has been illustrated for brevity. Specifically, each channel may include plural first switches 52 and one second switch 54. The first switches 52 and the second switch 54 are electrically connected at first ends to plural first photo detectors 53 and a second photo detector 55 respectively, and are electrically connected at second ends together to a first input 511 of a detection circuit 51 via a sense line 56. According to one aspect of the embodiment, the second switch 54 (e.g., top one) and the second photo detector 55 in a channel are covered by a light shielding cover 61, while others (first) switches 52 and the first photo detectors 53 of the same channel are not covered by the light shielding cover 61 (but in the detection area 22).

In operation, the second switch 54 covered by the light shielding cover 61 is turned on, and a signal generated by an associated (second) photo detector 55 is temporarily stored as a background signal that is fed to the second input 512 of the detection circuit 51. Subsequently, the first switches 52 are controllably turned on in a predetermined sequence. It is noted that the second switch 54 and the first switches 52 are manufactured with the substantially same coupling capacitance. The signal generated by associated (first) photo detector 53 and the background signal are fed to the two inputs 511 and 512 (of the differential pair) of the detection circuit 51, thereby suppressing current change in the photo detectors 53 and 55 due to environment (e.g., temperature) change.

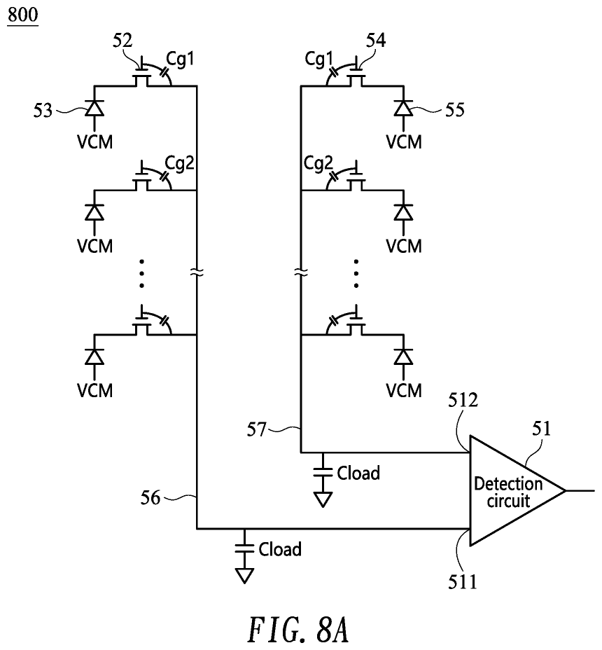

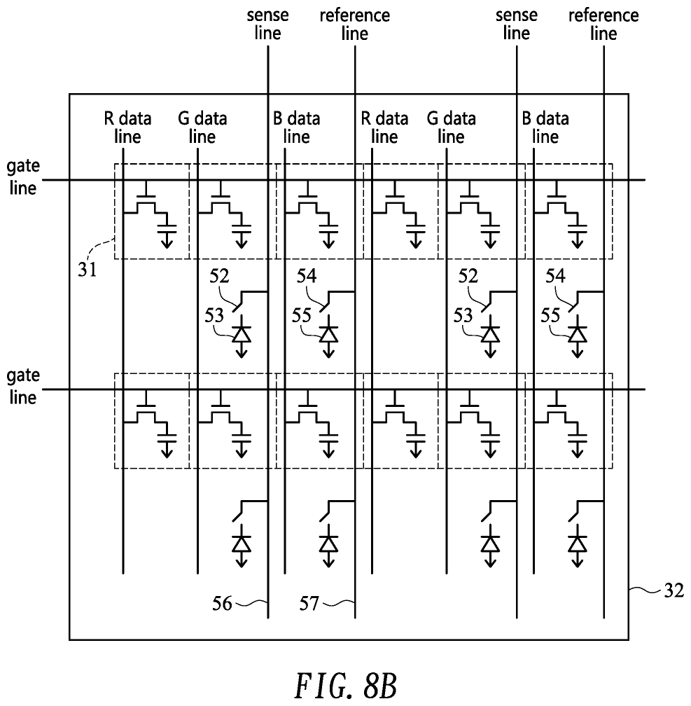

FIG. 8A and FIG. 8B show circuit diagrams illustrating an optical fingerprint detecting system 800 according to a fourth embodiment of the present invention capable of overcoming the drawbacks associated with FIG. 4. The system 800 is similar to the system 600 (FIG. 6B) with the exception that the second photo detectors 55 of the present embodiment are individually light-blocked (or light-insensitive) while they are manufactured. Therefore, the light shielding cover 61 as used in the system 600 (FIG. 6A) is not required. Specifically, the first photo detectors 53 are electrically connected to the sense line 56 via the first switches 52 respectively, and the second photo detectors 55 are electrically connected to the reference line 57 via the second switches 54 respectively. The system 800 may include cells 31 (e.g., red-green-blue cells or RGB cells), through which light (e.g., generated by a backlight 32 of a liquid crystal display) passes and then illuminates the surface of a finger. The light reflected from the finger is received by the first photo detectors 53 but not the second photo detectors 55. The operation of the system 800 is the same as that of the system 600, details of which are thus omitted for brevity.

Although specific embodiments have been illustrated and described, it will be appreciated by those skilled in the art that various modifications may be made without departing from the scope of the present invention, which is intended to be limited solely by the appended claims.

What is claimed is:

1. An optical fingerprint detecting system, comprising:
a detection circuit with a differential pair of two inputs including a first input and a second input;
a plurality of first photo detectors;
a plurality of first switches that are electrically connected at first ends to the first photo detectors respectively, and are electrically connected at second ends together to the first input of the detection circuit via a sense line; and
a plurality of second switches that are electrically connected at first ends together to the second input of the detection circuit via a reference line.

2. The system of claim 1, wherein the detection circuit comprises a differential amplifier that amplifies difference between the two inputs of the differential pair but suppresses a voltage common to the two inputs.

3. The system of claim 1, wherein the second switches and the first switches are symmetrically manufactured such that the first switch and the second switch of the same pair have substantially same coupling capacitance.

4. The system of claim 1, wherein second ends of the second switches are electrically connected to a constant bias voltage.

5. The system of claim 4, wherein the first switches are controllably turned on in a predetermined sequence, while the second switches are always turned off.

6. The system of claim 1, further comprising:
a plurality of second photo detectors; and
at least one light shielding cover disposed on a periphery of a detection area;
wherein second ends of the second switches are electrically connected to the second photo detectors respectively.

7. The system of claim 6, wherein the second switches and the second photo detectors are covered by the light shielding cover, while the first switches and the first photo detectors are not covered by the light shielding cover but in the detection area.

8. The system of claim 7, wherein the first switches and the second switches are controllably turned on in a predetermined sequence, and a same pair of the first switch and the second switch are either turned on or off at the same time.

9. The system of claim 1, further comprising:
a plurality of second photo detectors, second ends of the second switches being electrically connected to the second photo detectors respectively.

10. The system of claim 9, wherein the second photo detectors are made light-blocked individually.

11. The system of claim 10, wherein the first switches and the second switches are controllably turned on in a predetermined sequence, and a same pair of the first switch and the second switch are either turned on or off at the same time.

12. An optical fingerprint detecting system, comprising:
a detection circuit with a differential pair of two inputs including a first input and a second input;
a plurality of first switches and a single second switch in each channel; and
a plurality of first photo detectors and a single second photo detector in each channel;
wherein the first switches and the second switch in the same channel are electrically connected at first ends to the first photo detectors and the second photo detector respectively, and are electrically connected at second ends together to the first input of the detection circuit via a sense line.

13. The system of claim 12, wherein the detection circuit comprises a differential amplifier that amplifies difference between the two inputs of the differential pair but suppresses a voltage common to the two inputs.

14. The system of claim 12, wherein the second switches and the first switches are manufactured with substantially same coupling capacitance.

15. The system of claim 12, further comprising:
at least one light shielding cover disposed on a periphery of a detection area to shield the second switch and the second photo detector from light.

16. The system of claim 15, wherein the second switch is turned on, and a signal generated by an associated second photo detector is temporarily stored as a background signal fed to the second input of the detection circuit, and the first switches are then controllably turned on in a predetermined sequence.
